(19) United States
(12) Patent Application Publication
(10) Pub. No.: US 2008/0320389 A1
(43) Pub. Date: Dec. 25, 2008

(54) Mobile Information Terminal and Display Control Program

(75) Inventors: Takashi Tanaka, Kanagawa (JP); Mari Iino, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/575,222

(22) PCT Filed: Sep. 1, 2005
(86) PCT No.: PCT/JP2005/016015

§ 371 Date: Mar. 14, 2007

(30) Foreign Application Priority Data
Oct. 5, 2004 (JP) 2004-292648

(51) Int. Cl. G06F 12/00; G06F 3/00; G06F 17/30

(52) U.S. Cl. 715/700

(57) ABSTRACT

The present invention aims at grasping comprehensively files including contents that meet a search condition and also improving a convenience. A mobile information terminal of the present invention having a display portion 10 for displaying contents of a plurality of files corresponding to respective applications, includes a contents search results display control portion 31 that has a function of acquiring files containing the contents that meet a search condition, a function of arranging acquired files in a predetermined layout every application, and a function of causing the display portion to display arranged files.

### TECHNICAL FIELD

The present invention relates to a mobile information terminal and a display control program.

### BACKGROUND ART

In addition to the use as the radio communicating unit such as the phone, the electronic mail, and the like, functional needs as the information managing unit for collecting necessary information immediately and storing collected information easily are escalating recently in the mobile information terminal such as the cellular phone, PDA (Personal Digital Assistance), and the like. Therefore, improvement of the searching function to access exactly necessary information is chosen an important theme for the product development.

Also, as the technology to display searched information on the cellular phone terminal, the technology to search current operating information as to the route, and the like and display the searched information on the cellular phone terminal when the operator accesses to the site, which provides information about operating situations of the train, etc., from the cellular phone terminal via the Internet and then designates the date, the route name, and the like is known (see Patent Literature 1, for example).

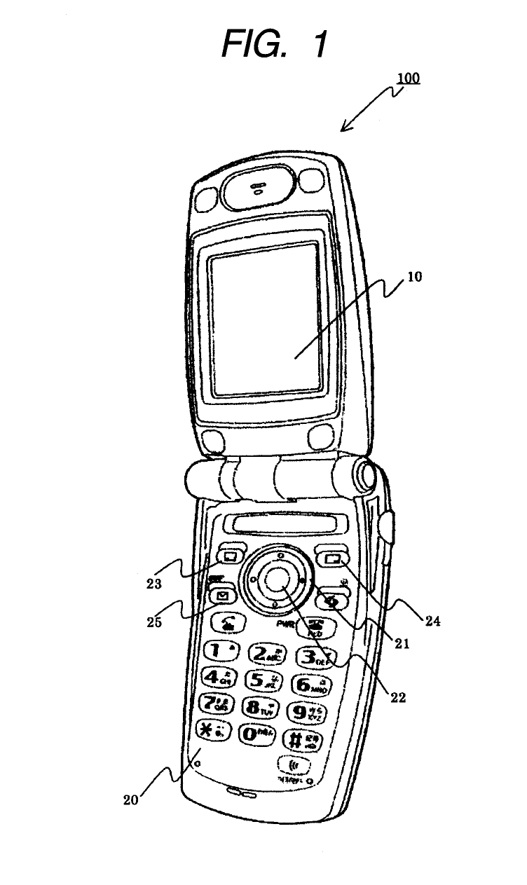

Patent Literature 1: JP-A-2002-308099 (pages 4 to 9, FIG. 1)

### DISCLOSURE OF THE INVENTION

### Problems that the Invention is to Solve

Meanwhile, it is seldom commonly the case that, when the operator intends to get any information, he or she wishes to get one type of information only. Normally the operator wishes to get plural types of information about the search condition (i.e., the item serving as the search key) in many cases. In particular, it is preferable that, regarding the information about a schedule, a phone book, an address book, and the like, which are managed by the mobile information terminal, plural pieces of information about one search item should be grasped simultaneously.

For example, when the operator checks a schedule on that day by starting a scheduler and designating the past date, sometimes such operator wishes to confirm a history of electronic mails that are exchanged on that day according to the schedule. In such case, the operator of the cellular phone terminal must terminate the scheduler once, then start a mailer of the electronic mail again, and search manually the electronic mail on that day by scrolling an electronic mail list. When the operator wishes to check both the outgoing mail and the incoming mail, the similar operation is required of both the receiving folder and the sending folder. Thus, such operation is complicated and consumes much time.

The present invention has been made in view of the above circumstances, and aims at providing a mobile information terminal and a display control program capable of grasping comprehensively files including contents that meet a search condition and also improving a convenience.

### Means for Solving the Problems

A mobile information terminal of the present invention having a display portion for displaying contents of a plurality of files corresponding to respective applications, includes an acquiring unit for acquiring files containing the contents that meet a search condition; an arranging unit for arranging acquired files in a predetermined layout every application; and a display controlling unit for causing the display portion to display arranged files. According to the above configuration, since an arranging unit for arranging the acquired files in a predetermined layout every application is provided, the results searched from a plurality of applications can be displayed intensively. Therefore, the files including the contents that meet the search condition can be grasped comprehensively, and also the convenience can be improved.

Also, in the mobile information terminal of the present invention, the arranging unit arranges files containing the contents that meet the search condition, together with attribute information of the files. According to the above configuration, since the arranging unit arranges files containing the contents that meet the search condition, together with attribute information of the files, the function of the application corresponding to the file can be utilized to look up a certain file displayed on the display portion, based on the attribute information. Therefore, the convenience can be further improved.

Also, in the mobile information terminal of the present invention, the arranging unit arranges the files containing the contents, which meet the search condition, in a display area by scrolling the files. According to the above configuration, since the arranging unit arranges the files containing the contents that meet the search condition in a display area by scrolling the files, a displayable area can be extended. Therefore, there is no need that all files should be arranged in the screen.

Also, in the mobile information terminal of the present invention, the arranging unit classifies the files containing the contents, which meet the search condition, on a tab basis every application and arranges the files. According to the above configuration, since the arranging unit classifies the files containing the contents that meet the search condition on a tab basis every application and arranges the files, the files handled by each application can be displayed on a tab basis. Therefore, the display screen becomes easy to see.

Also, in the mobile information terminal of the present invention, the display controlling unit for causing the display portion to display an outgoing electronic mail and an incoming electronic mail distinguishably. According to the above configuration, since the display controlling unit for causing the display portion to display an outgoing electronic mail and an incoming electronic mail distinguishably, the searched results of the electronic mail files that meet the search condition such as the date, or the like can be grasped while distinguishing between the outgoing electronic mail and the incoming electronic mail.

Also, in the mobile information terminal of the present invention, the arranging unit arranges acquired image files in a thumbnail mode. According to the above configuration, since the arranging unit arranges acquired image files in the thumbnail mode, the searched results of the image files can be arranged in a compact fashion to know the contents. Therefore, the operator can easily grasp the contents of the image files.

Also, a display control program of causing a display portion to display contents of a plurality of files corresponding to respective applications and causing a computer to function as an acquiring unit for acquiring files containing the contents that meet a search condition; an arranging unit for arranging acquired files in a predetermined layout every application; and a display controlling unit for causing the display portion to display arranged files.

### ADVANTAGES OF THE INVENTION

According to the present invention, the results searched from a plurality of applications can be displayed by arranging the acquired filed in a predetermined layout every application. Therefore, the files including the contents that meet the search condition can be grasped comprehensively and also the convenience can be improved.

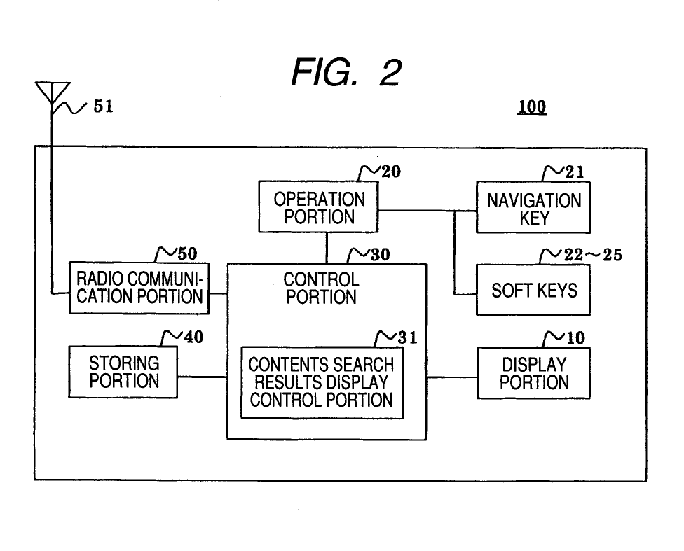

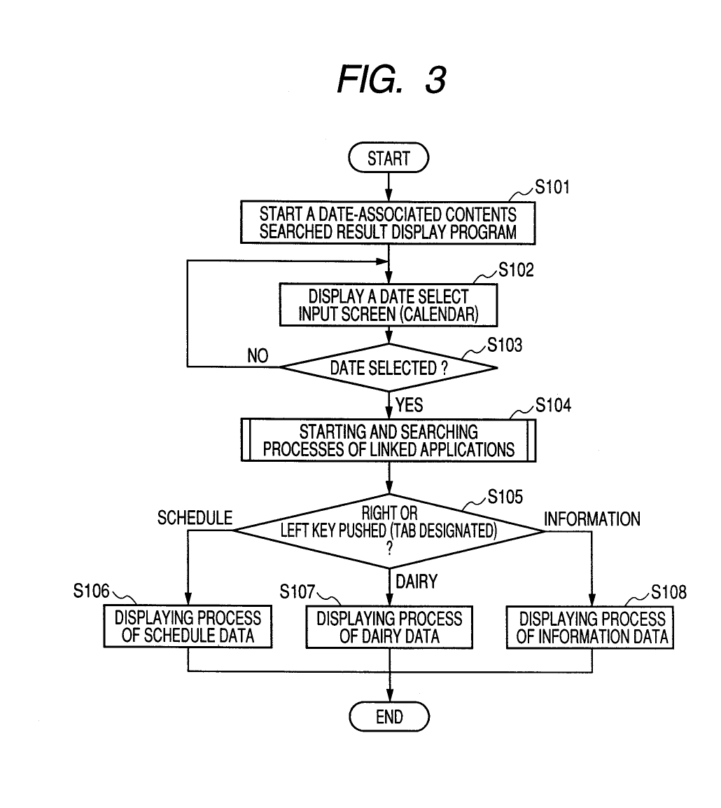

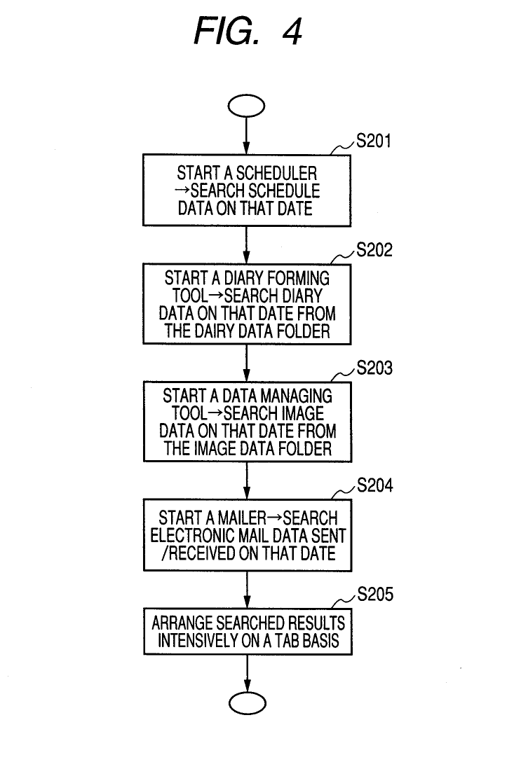

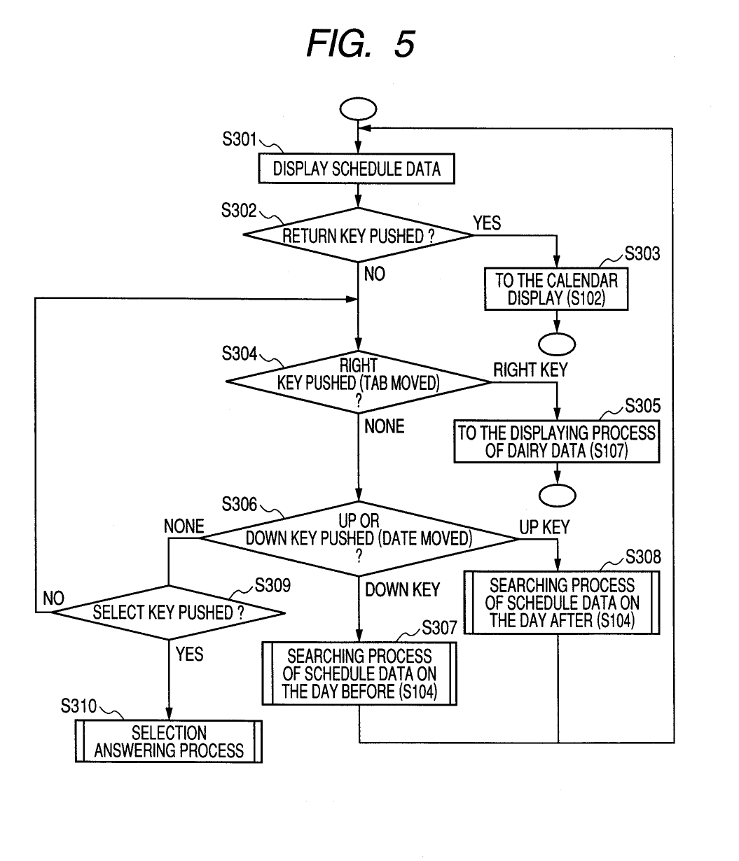

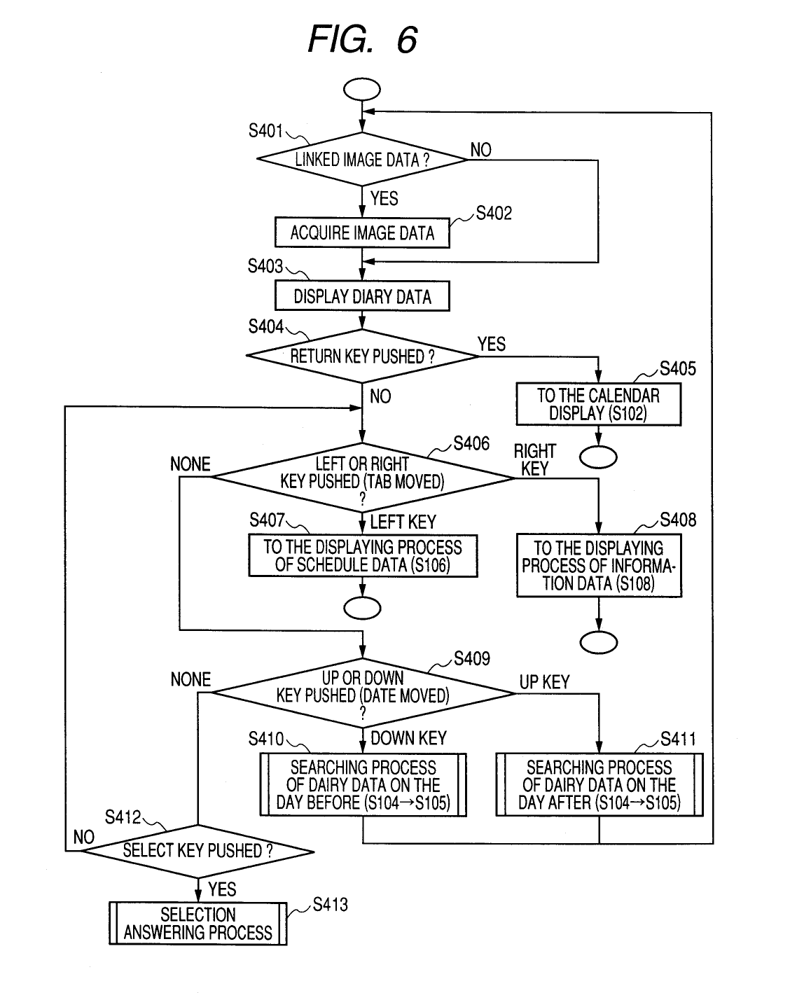

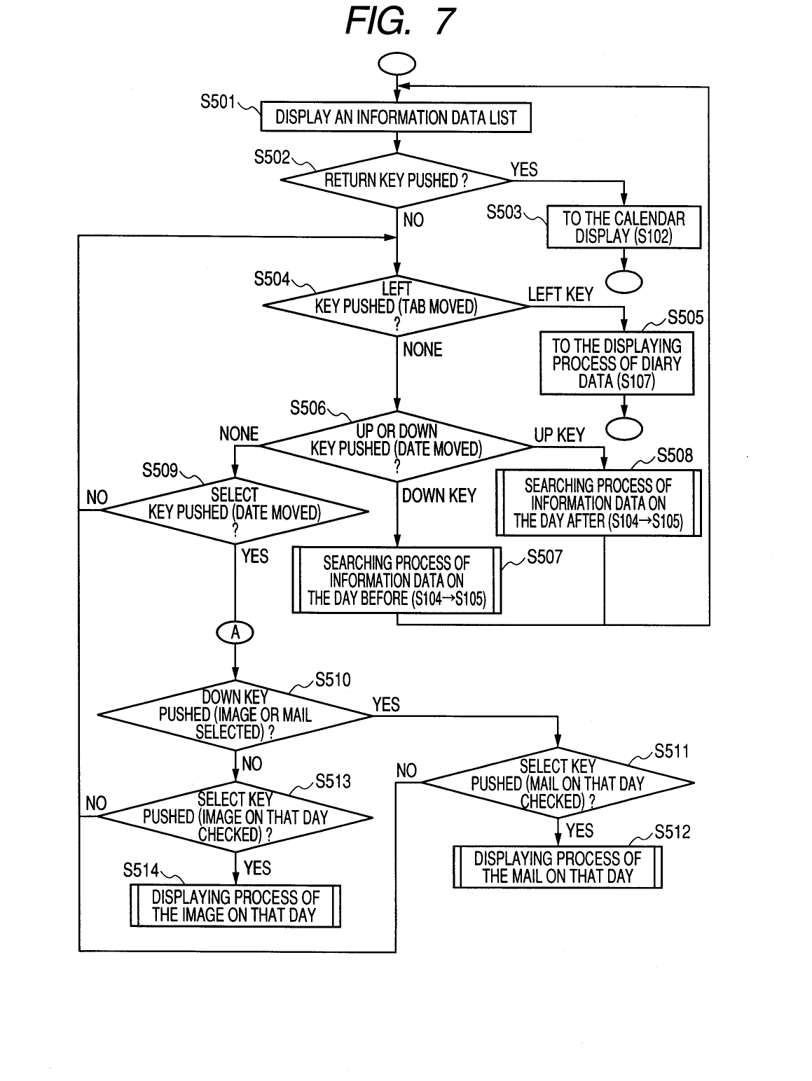

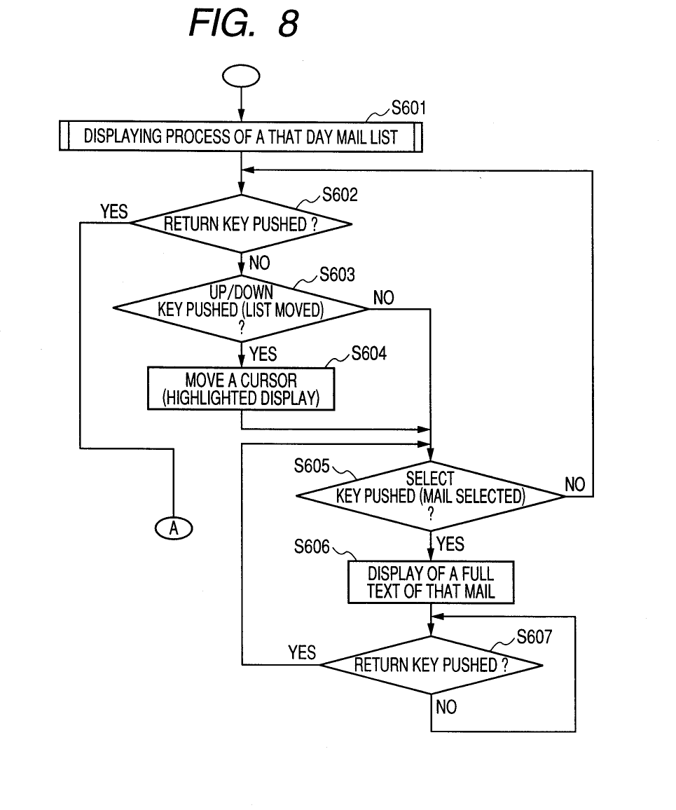

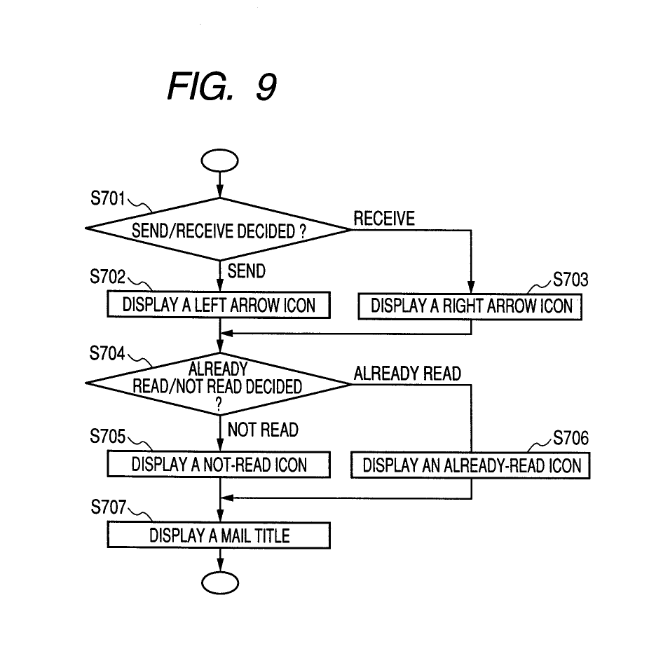

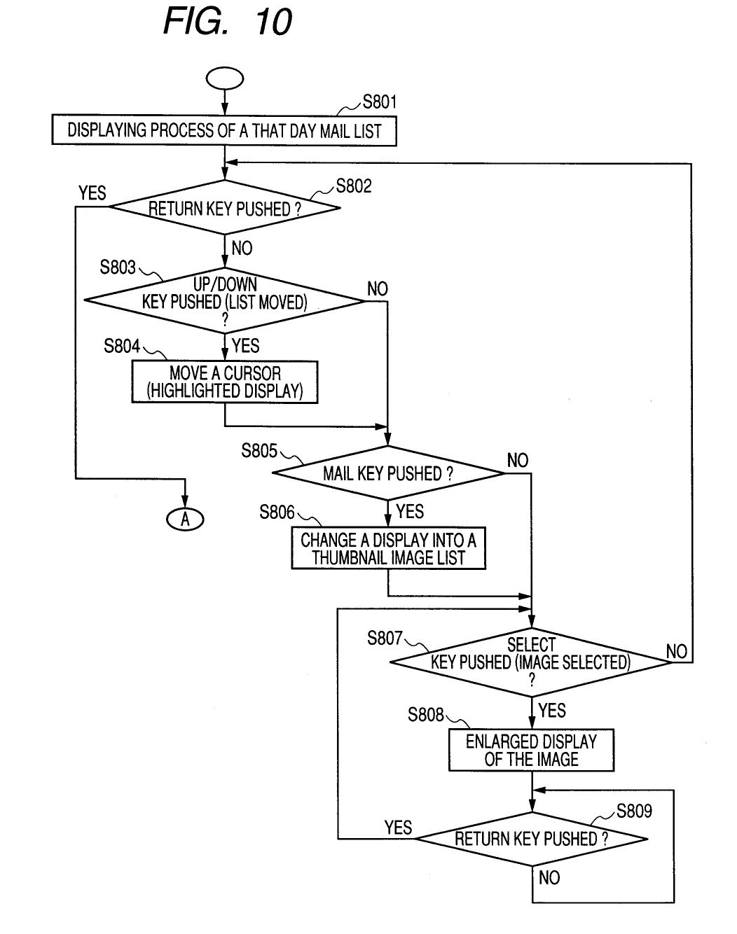

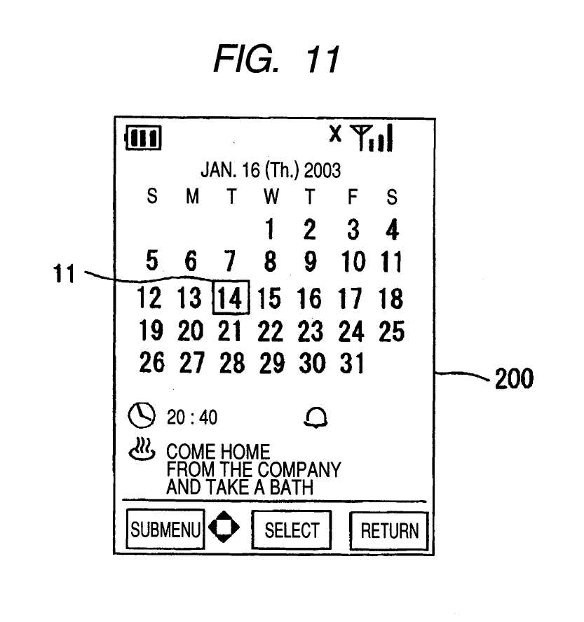

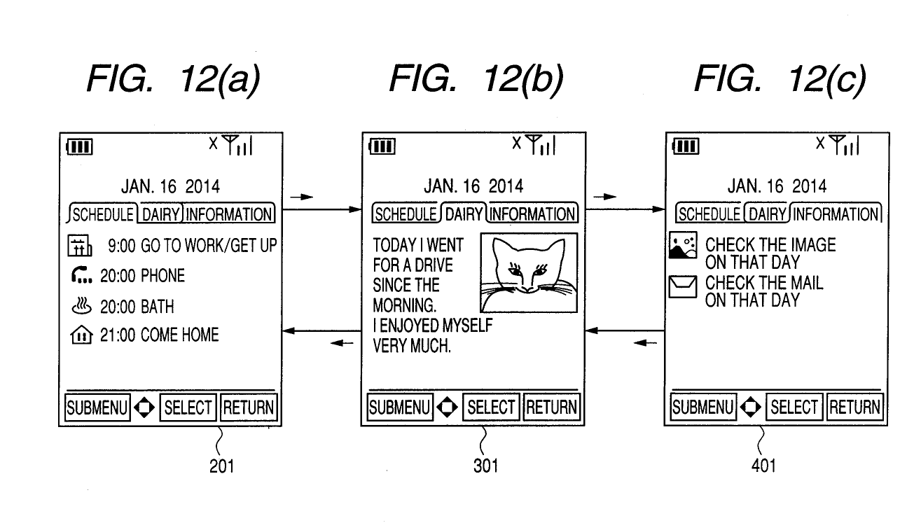

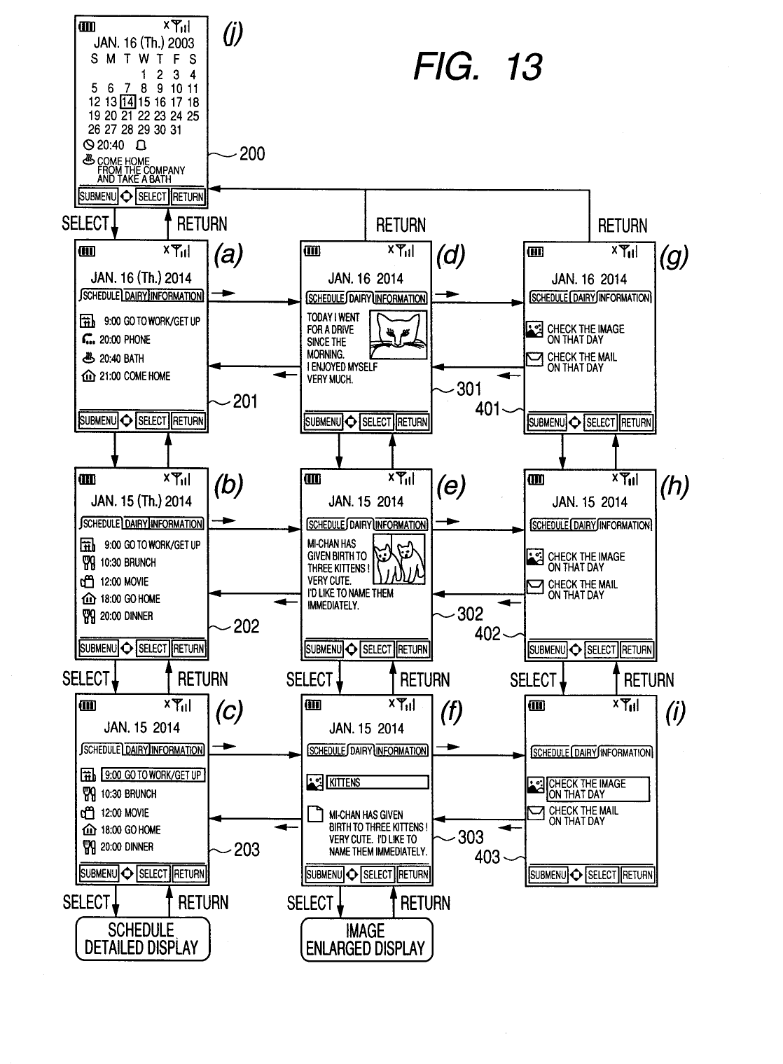

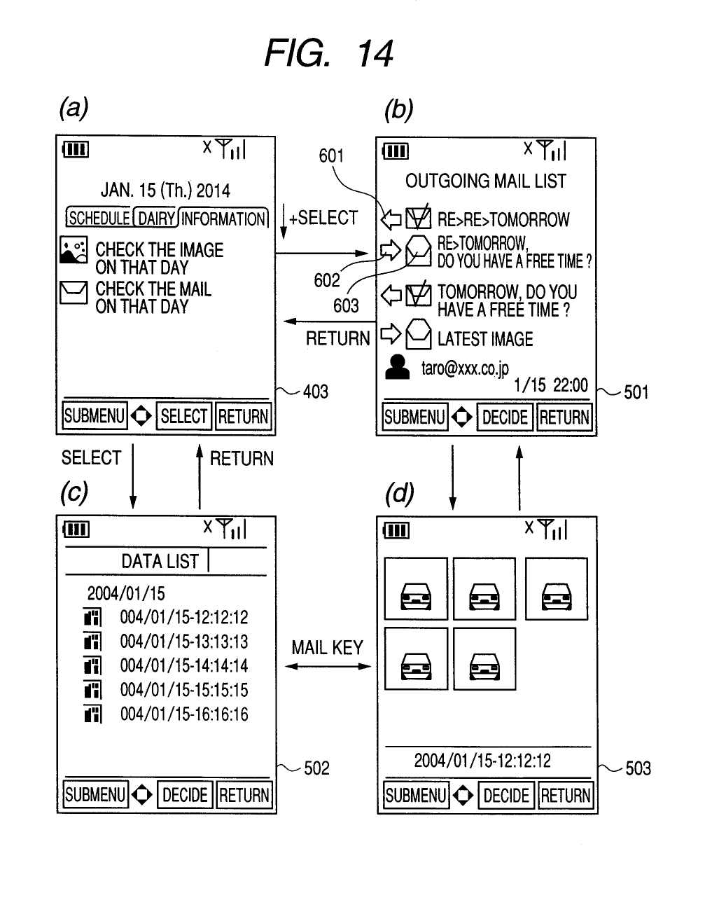

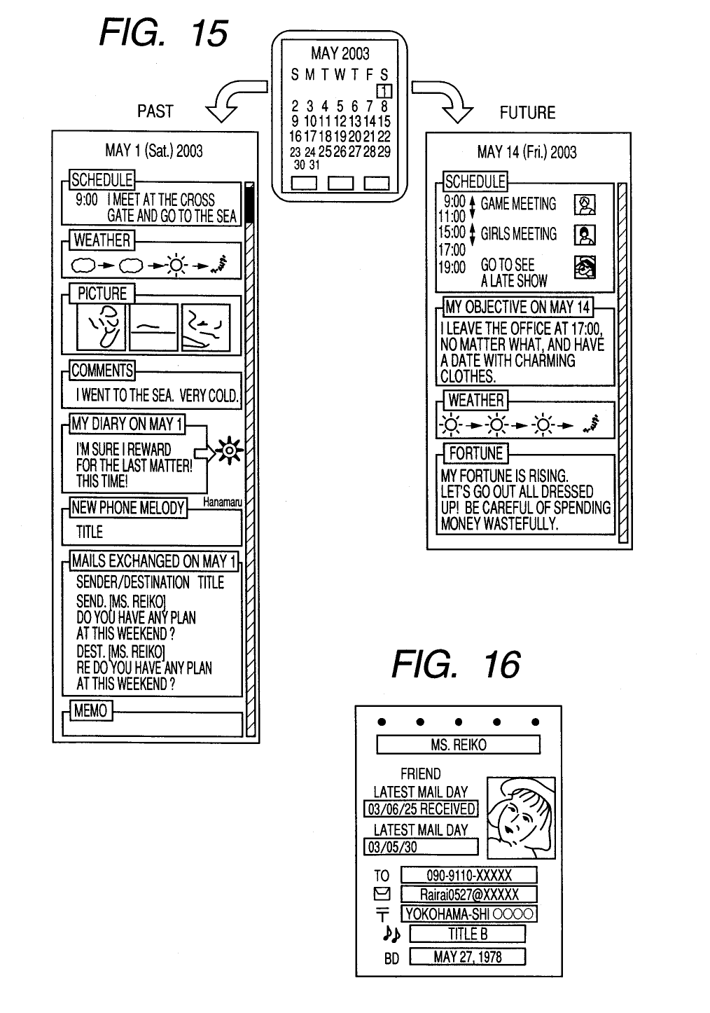

### BRIEF DESCRIPTION OF THE DRAWINGS

[FIG. 1] A view showing an outer appearance of a cellular phone terminal in an embodiment 1 of the present invention.

[FIG. 2] A view showing an internal configuration of the cellular phone terminal in the embodiment 1 of the present invention.

[FIG. 3] A flowchart showing procedures of contents searching and results displaying operations in the cellular phone terminal in the embodiment 1 of the present invention.

[FIG. 4] A flowchart showing procedures of stating and searching processes of linked applications.

[FIG. 5] A flowchart showing procedures of a displaying process of a schedule file.

[FIG. 6] A flowchart showing procedures of a displaying process of a diary file.

[FIG. 7] A flowchart showing procedures of a displaying process of an information file.

[FIG. 8] A flowchart showing procedures of a displaying process of electronic mails that are exchanged on that day.

[FIG. 9] A flowchart showing procedures of a displaying process of a that day mail list.

[FIG. 10] A flowchart showing procedures of a displaying process of an image file acquired or generated on that day.

[FIG. 11] A view showing an example of a screen display of a date choosing input screen.

[FIG. 12] A view showing a display transition of a tab screen in response to leftward/rightward key operations of a navigation key.

[FIG. 13] A view showing a display transition of a tab screen and items in the tab screen in response to leftward/rightward and upward/downward key operations of the navigation key.

[FIG. 14] A view showing a display transition in an information tab screen.

[FIG. 15] A view showing an example of a screen display of the cellular phone terminal in an embodiment 2 of the present invention when searched results in a plurality of applications by using a date as a key are displayed.

[FIG. 16] A view showing an example of a screen display of the cellular phone terminal in an embodiment 3 of the present invention when searched results in a plurality of applications are displayed by using a name as a key.

### DESCRIPTION OF REFERENCE NUMERALS

10 display portion
11 cursor
20 operation portion
21 navigation key
22, 23, 24, 25 soft key
30 control portion
31 contents search results display control portion
40 storing portion
50 radio communication portion
51 antenna
100 cellular phone terminal

### BEST MODE FOR CARRYING OUT THE INVENTION

Mobile information terminals according to embodiments of the present invention will be explained in detail with reference to the accompanying drawings hereinafter. In following embodiments, a cellular phone terminal will be explained as an example of the mobile information terminal. In this case, the mobile information terminal is not limited to the cellular phone terminal, and PDA (Personal Digital Assistance), and the like can also be applied. Also, the same reference symbols are affixed to respective portions having the same functions throughout all the drawings used to explain the embodiments, and their duplicated explanations will be omitted herein.

### Embodiment 1

FIG. 1 is a view showing an outer appearance of a cellular phone terminal in an embodiment 1 of the present invention. A cellular phone terminal 100 shown in FIG. 1 includes a display portion 10 for displaying the contents of a plurality of files corresponding to respective applications, and an operating portion 20. Here, the file stores the contents, and the application is the program used to process the contents stored in the file. Also, the cellular phone terminal 100 includes a contents search results display control portion 31 (see FIG. 2) that has a function of acquiring the file containing the contents that meet the search condition, a function of arranging the acquired files in a predetermined layout every application, and a function of causing the display portion 10 to display the arranged file.

The display portion 10 is composed of a liquid crystal display, an organic EL display, or the like, and displays characters, images, and the like as the display to urge the operator of the cellular phone terminal 100 to input and various displays to respond to the input. The operating portion 20 is composed of various keys and buttons, and has a navigation key 21 for scrolling a screen longitudinally and laterally, a soft key 22 used to select, other soft keys 23, 24, 25, and the like. The operator of the cellular phone terminal 100 operates these keys and buttons to input.

FIG. 2 is a view showing an internal configuration of the cellular phone terminal in the embodiment 1 of the present invention. The cellular phone terminal 100 includes a control portion 30, a storing portion 40, and a radio communication portion 50 in addition to the above display portion 10 and the operation portion 20.

The control portion 30 supervises/controls the operations of the overall cellular phone terminal, and has the contents search results display control portion 31. The contents search results display control portion 31 controls configurations and displays of the searched results of a plurality of contents displayed on a screen of the display portion 10. The control portion 30 realizes control operations by running various control programs stored previously in the cellular phone terminal. The contents search results display control portion 31 executes the control to apply control programs such as a “date-associated contents search results display program”, a “name-associated contents search results display program”, and the like, described later, to a plurality of files corresponding to respective applications and then display intensively the results searched from a plurality of applications.

The storing portion 40 is composed of a memory, and stores various files. For example, the electronic mail file that have been sent/received, formed memo and diary files, image files acquired by picking up the image by the attached electronic camera (not shown) or downloading the image, etc. are stored. Also, the above control programs, various application programs (applications) corresponding to a plurality of files as the searched object of the control program, image files such as formats, icons, and the like used in the screen display, etc. are stored in this storing portion. As the application program corresponding to the file as the searched object, there are a mailer for the electronic mail, a scheduler, the Web browser, data management tools for an address book, images, and others. But their details will be described later. In this case, the storing portion may be provided on the outside of the cellular phone terminal and may be connected via the network.

The radio communication portion 50 sends/receives the phone call, the electronic mail, and the like via radio communication. The publicly-known approaches may be employed as the phone connection establishing method, the electronic mail sending/receiving method, and the like. Therefore, explanation of detailed configuration and operation of the radio communication portion 50 will be omitted herein.

Next, an operation of the cellular phone terminal 100 to display the searched results of a plurality of contents in association with one search condition will be explained in detail hereunder.

FIG. 3 is a flowchart showing procedures of contents searching and results displaying operations in the cellular phone terminal in the embodiment 1 of the present invention. By way of example, the case where the operator of the cellular phone terminal 100 selects the date and displays selectively information about schedule, diary, mail, and others in association with such date will be explained hereunder. At first, a “date-associated contents searched result display program” is started by a predetermined operation such as the key pushing on the operating portion 20 (step S101). This “date-associated contents searched result display program” is stored in the storing portion 40. The “date-associated contents searched result display program” is the program that is applied to acquire the files containing the contents, which meet the search condition, from a plurality of files corresponding to respective applications in response to the search condition of “date”, arrange the acquired files together with their attribute information in a predetermined layout every application, and display the arranged files on the display portion 10. The contents search results display control portion 31 of the control portion 30 displays a date select input screen 200 as an initial screen on the display portion 10 (step S102). FIG. 11 is a view showing an example of a screen display of a date select input screen 200.

The operator of this cellular phone terminal moves a cursor 11 on a calendar screen shown in FIG. 11 by operating up/down/left/right keys of the navigation key 21, and then selects the date (sets the search condition) by pushing down the soft key 22 (step S103). When the date is selected, the contents search results display control portion 31 starts a plurality of applications linked as the search object to execute the search of the contents satisfying the search condition, and then executes the searching process (step S104). Details of this process will be explained subsequently hereunder.

FIG. 4 is a flowchart showing procedures of stating and searching processes of the linked applications. In the present embodiment, a scheduler, a diary forming tool, a data managing tool, and a mailer are started in association with the date, and then the link is set to search the contents of the files corresponding to the applications respectively. At first, the contents search results display control portion 31 starts the scheduler and then searches the selected schedule files on that date (step S201). Then, such display control portion 31 starts the diary forming tool and then searches the diary files on that date in the dairy data folder (step S202).

Similarly, such display control portion 31 starts the data managing tool and then searches the image files acquired on that date from the image file folder (step S203), and then starts the mailer and then searches the electronic mail files sent/received on that date (step S204). Then, the contents search results display control portion 31 arranges intensively the searched results of a plurality of contents acquired according to the above procedures in a predetermined layout on a tab basis every application (step S205). In this case, the application to which the link is set in association with the date may be set arbitrarily, and it does not matter if the operator of the cellular phone terminal sets freely such applications. With the above, the searching process of a plurality of applications is ended.

Returning to a flowchart in FIG. 3, the search applied to a plurality of files corresponding to respective applications while using the selected data as the key is ended. Then, the contents search results display control portion 31 senses whether or not the right or left key of the navigation key 21 is input (step S105). At first, since the right or left key is not pushed, the displaying process of schedule data is executed (step S106). Details of the displaying process will be described later, but an image 201 of the schedule tab on that day, as shown in FIG. 12(a), is displayed on the display portion 10 by this displaying process. In contrast, if the right key of the navigation key 21 is pushed thereafter, the contents search results display control portion 31 executes the displaying process of the dairy file. Then, an image 301 of the dairy tab on that day, as shown in FIG. 12(b), is displayed on the display portion 10 (step S107). That is, the tab is shifted rightward by one position. Similarly, if the right key of the navigation key 21 is pushed, an image 401 of the information tab on that day, as shown in FIG. 12(c), is displayed by the displaying process of the information file (step S108). That is, the tab is further shifted rightward by one position. In this manner, the tab can be switched freely by pushing the left/right keys of the navigation key 21.

Next, the process of displaying the above three tabs will be explained in detail hereunder. At first, the displaying process of the schedule file (step S106 in a flowchart of FIG. 3) will be explained hereunder. FIG. 5 is a flowchart showing procedures of a displaying process of the schedule file. At first, the contents search results display control portion 31 displays the schedule file acquired in step S104 in FIG. 3 as an image 201 of the schedule tab on that day (step S301). In the display state shown in FIG. 13(a), the contents search results display control portion 31 senses whether or not the return key (soft key 24) is pushed (step S302). If such display control portion 31 senses that the return key is pushed, the display portion goes back to the date select input screen (calendar display) shown in FIG. 13(j) (S303). Therefore, the display portion is brought into such a state that the operator can select the date once again.

In contrast, if the contents search results display control portion 31 does not sense that the return key is pushed, such portion senses whether or not the right key of the navigation key 21 is pushed (step S304). If such display control portion senses that the right key is pushed, the process is transferred to the displaying process of the dairy data described later (step S305). Therefore, an image 301 of the dairy tab on that day, as shown in FIG. 13(d), is displayed. That is, the display can be shifted to the “dairy” tab by pushing the right key.

In contrast, if the contents search results display control portion 31 senses that the right key is pushed, such portion senses whether or not the up or down key of the navigation key is pushed (step S306). If such display control portion senses that the down key is pushed, it executes the searching process of the schedule file on the day before (step S307). This is the process that goes to the process in step S104 in a flowchart in FIG. 3 to search the schedules dated on the “day before”. Then, the process returns to the procedure in step S301 once gain to display the schedules on the “day before”. Similarly, if such display control portion senses that that the up key is pushed, it executes the searching process of the schedule file on the day after (step S308). Also, this is the process that goes to the process in step S104 in a flowchart in FIG. 3 to search the schedules dated on the “day after”. Then, the process returns to the procedure in step S301 once gain to display the schedules on the “day after”. FIG. 13(b) shows an example of the display screen of an image 202 of the schedule tab on the day before, which is displayed when the down key is pushed. Here, when the right key is pushed in this state, the display is shifted to an image 302 of the diary tab on the day before according to the similar procedures while keeping the same data as it is, as shown in FIG. 13(e).

In contrast, if the contents search results display control portion 31 does not sense that the up or down key is pushed, such display control portion senses whether or not the “select key” (soft key 22) is pushed (step S309). If such display control portion senses that the “select key” is pushed, it executes a selection answering process (step S310). Here, the display portion is brought into a display mode of the schedule on that day, and detailed contents of the selected item are displayed. More concretely, as shown in FIG. 13(c), the cursor is displayed (highlighted display) on the image 203 of the schedule tab. Therefore, when the operator moves the highlighted display portion by the up/down key of the navigation key 21 and then pushes the select key at a desired position, the contents search results display control portion 31 displays the detailed contents of the schedule item (not shown). Here, even when the right key is pushed in the state shown in FIG. 13(c), for example, the display can be shifted to an image 303 of the diary tab on the day before according to the similar procedures while keeping the same data as it is, as shown in FIG. 13(f). With the above, the procedures of the schedule file displaying process are ended.

Next, the displaying process of the dairy file (step S107 in a flowchart in FIG. 3) will be explained hereunder. FIG. 6 is a flowchart showing procedures of the displaying process of the diary file. When the diary tab is selected by pushing the left/right key of the navigation key 21, or the like, the contents search results display control portion 31 decides whether or not the image data that are linked with the dairy file acquired in step S104 in FIG. 3 is present (step S401). If the image data is present, such display control portion acquires the linked image data (step S402), and then displays a thumbnail image together with a diary text file as an image 301 of the diary tab on that day, as shown in FIG. 13(d) (step S403). In contrast, if the image data is not present, such display control portion displays only the text file.

In the display state shown in FIG. 13(d), the contents search results display control portion 31 senses whether or not the “return key” (soft key 24) is pushed (step S404). If such display control portion senses that the return key is pushed, the display portion returns to the date select input screen (calendar display) shown in FIG. 13(j) (step S405). Therefore, the display portion is brought into such a state that the operator can select the date once again.

In contrast, if the contents search results display control portion 31 does not sense that the return key is pushed, such display control portion senses whether or not the left or right key of the navigation key 21 is pushed (step S406). If such display control portion senses that the left key is pushed, the process goes to the above displaying process of the schedule file (step S407). Accordingly, the image 210 of the schedule tab on that day as shown in FIG. 13(a) is displayed. That is, the display can be moved to the “schedule” tab by pushing the left key. In contrast, if such display control portion senses that the right key is pushed, the process goes to the displaying process of the information file described later (step S408). Accordingly, the image 401 of the information tab on that day as shown in FIG. 13(g) is displayed. That is, the display can be moved to the “information” tab by pushing the right key.

In contrast, if the contents search results display control portion 31 does not sense that the left or right key is pushed, such display control portion senses whether or not the up or down key of the navigation key 21 is pushed (step S409). If such display control portion senses that the down key is pushed, it executes the searching process of the dairy file on the day before (step S410). This is the process that goes to the process in step S104 in a flowchart in FIG. 3 to search the diary files dated on the “day before”. Then, the process goes back to the procedure in step S104 once again, and the dairy file on the “day before” is displayed. Similarly, if such display control portion senses that the up key is pushed, it executes the searching process of the dairy file on the day after (step S411). This is the process that goes to the process in step S104 in a flowchart in FIG. 3 to search the diary files dated on the “day after”. Then, the process goes back to the procedure in step S104 once again, and the dairy file on the “day after” is displayed. FIG. 13(e) shows an example of the screen display of the image 302 of the dairy tab on the day before displayed when the down key is pushed. Here, if the left key is pushed in this state, the display is shifted to the image 202 of the schedule tab on the day before according to the similar procedures while keeping the same data as it is, as shown in FIG. 13(b). Also, if the right key is pushed in this state, the display is shifted to the image 202 of the information tab on the day before according to the similar procedures while keeping the same data as it is, as shown in FIG. 13(h).

In contrast, if the contents search results display control portion 31 does not sense that the up or down key is pushed, such display control portion senses whether or not the “select key” (soft key 22) is pushed (step S412). If such display control portion senses that the select key is pushed, it executes the selection answering process (step S413). Here, the display portion comes into an image enlarged display mode linked with the diary dated on that date, and the selected image is displayed on a full screen. More concretely, as shown in FIG. 13(f), the cursor is displayed (highlighted display) on the image 303 of the diary tab. Accordingly, when the operator moves the highlighted display portion by the up/down key of the navigation key 21 (when a plurality of images are present) and then pushes the select key in a desired position, the contents search results display control portion 31 displays the image file on a full screen. Here, if the left key is pushed in the state in FIG. 13(f), the display can be shifted to the image 203 of the schedule tab on the day before according to the similar procedures while keeping the same data as it is, as shown in FIG. 13(c). Also, if the right key is pushed in the state in FIG. 13(f), the display can be shifted to the image 403 of the information tab on the day before according to the similar procedures while keeping the same data as it is, as shown in FIG. 13(i). With the above, the procedures of the displaying process of the dairy file are ended. In this case, in displaying the image file, the display of the image file is not limited to a full screen mode, and the image file may be arranged in a thumbnail mode.

Next, the displaying process of the information file (step S108 in a flowchart of FIG. 3) will be explained hereunder. FIG. 7 is a flowchart showing procedures of the displaying process of the information file. When the information tab is selected by pushing the left or right key of the navigation key 21, or the like, the contents search results display control portion 31 displays the image 401 of the information tab on that day as shown in FIG. 13(g), based on the image, the electronic mail list, etc. acquired in step S104 in FIG. 3 (step S501). In the display state shown in FIG. 13(g), the contents search results display control portion 31 senses whether or not the “return key” (soft key 24) is pushed (step S502). If such display control portion senses that the return key is pushed, the display portion returns to the date select input screen (calendar display) shown in FIG. 13(j) (step S503). Therefore, the display portion is brought into such a state that the operator can select the date once again.

In contrast, if the contents search results display control portion 31 does not sense that the return key is pushed, such display control portion senses whether or not the left key of the navigation key 21 is pushed (step S504). If such display control portion senses that the left key is pushed, the process goes to the displaying process of the foregoing diary file (step S505). Accordingly, the image 301 of the dairy tab on that day as shown in FIG. 13(d) is displayed. That is, the display can be moved to the “diary” tab by pushing the left key.

If the contents search results display control portion 31 does not sense that the left key is pushed, such display control portion senses whether or not the up or down key of the navigation key 21 is pushed (step S506). If such display control portion senses that the down key is pushed, it executes the searching process of information data on the day before (step S507). This is the process that goes to the process in step S104 in a flowchart in FIG. 3 to search the information files (i.e., the image and the electronic mail) dated on the “day before”. Then, the process goes back to the procedure in step S501 once again, and the information file on the “day before” is displayed. Similarly, if such display control portion senses that the up key is pushed, it executes the searching process of the information file on the day after (step S508). Also, this is the process that goes to the process in step S104 in a flowchart in FIG. 3 to search the information files dated on the “day after”. Then, the process goes back to the procedure in step S501 once again, and the information file on the “day after” is displayed. FIG. 13(h) shows an example of the screen display of the image 402 of the information tab on the day before displayed when the down key is pushed. Here, for example, if the left key is pushed in this state, the display is shifted to the image 302 of the dairy tab on the day before according to the similar procedures while keeping the same data as it is, as shown in FIG. 13(e).

In contrast, if the contents search results display control portion 31 does not sense that the up or down key is pushed, such display control portion senses whether or not the “select key” (soft key 22) is pushed (step S509). If such display control portion senses that the select key is pushed, the display portion comes into a check mode of the image of the electronic mail on that day so that the detailed contents of the selected item can be displayed. Further, the contents search results display control portion 31 senses whether or not the down key of the navigation key 21 is pushed (step S510). More concretely, since the cursor is displayed (highlighted display) on the image 403 of the information tab as shown in FIG. 13(i), the operator moves the cursor to “that day image check” or “that day mail check” by the up/down key of the navigation key 21. That is, the “that day mail check” is highlight-displayed when the down key is pushed while the image 403 of the information tab shown in FIG. 13(i) is displayed, while the “that day image check” is still highlight-displayed when the down key is not pushed.

If the contents search results display control portion 31 senses that the down key is not pushed, such display control portion senses whether or not the select key is pushed (step S511). Then, such display control portion senses that the select key is pushed, it executes the displaying process of the electronic mail exchanged on that day (step S512). In contrast, if the contents search results display control portion 31 does not sense that the select key is pushed, such display control portion senses whether or not the select key is pushed (step S513). If such display control portion senses that the select key is pushed, it executes the displaying process of the image file acquired on that day (step S514). The details of the displaying process of the that day mail (step S512) and the displaying process of the that day image (step S514) will be described later. Here, for example, if the left key is pushed in the state shown in FIG. 13(i), the display can be shifted to the image 303 of the dairy tab on the day before according to the similar procedures while keeping the same data as it is, as shown in FIG. 13(f). In the above explanation, the case where the information file on the day after is displayed when the up key of the navigation key 21 is pushed whereas the information file on the day before is displayed when the down key is pushed is illustrated. But the information file on the day after may be displayed when the down key of the navigation key 21 is pushed whereas the information file on the day before may be displayed when the up key is pushed.

Next, the displaying process of the that day mail (step S512) and the displaying process of the that day image (step S514) will be explained in detail.

FIG. 8 is a flowchart showing procedures of the displaying process of the electronic mails that are exchanged on that day. First, the “that day mail check” is selected in the display state of the image 403 of the information tab shown in FIG. 14(a). Then, the contents search results display control portion 31 generates a list of the electronic mails exchanged on that day based on data of the electronic mail acquired in step S104 in FIG. 3, and then displays the list as an image 501 of the that day mail list shown in FIG. 14(b) (step S601).

Then, procedures of the displaying process of the image 501 of the that day mail list will be explained hereunder. FIG. 9 is a flowchart showing procedures of the displaying process of the that day mail list. At first, the contents search results display control portion 31 decides that the individual acquired electronic mail data corresponds to either the outgoing mail or the incoming mail (step S701). If the acquired electronic mail is the outgoing mail, a left arrow icon is added as the item of the list and then displayed (step S702). If the acquired electronic mail is the incoming mail, a right arrow icon is added as the item of the list and then displayed (step S703).

Then, the contents search results display control portion 31 decides that the individual acquired electronic mail file corresponds to either the not-read mail or the already-read mail (step S704). If the acquired electronic mail file is the not-read mail, a not-read icon is added as the item of the list and then displayed (step S705). In contrast, if the acquired electronic mail file is the already-read mail, an already-read icon is added as the item of the list and then displayed (step S706).

Then, the contents search results display control portion 31 displays a title of the electronic mail in association with the icon display, and generates a that day mail list (step S707). For example, in the image 501 of the that day mail list shown in FIG. 14(b), it is understood based on the display of a send icon 601 that the mail at the top of the list is the mail that the operator of the cellular phone terminal sent. Also, it is understood based on the display of a receive icon 602 that the second mail of the list is the mail that the operator of the cellular phone terminal received. In addition, it is understood based on the display of a receive icon 603 that the second mail is the mail that the operator of the cellular phone terminal has already checked the contents. With the above, the displaying process of the that day mail list is ended.

Returning to a flowchart in FIG. 8, in the display state shown in FIG. 14(b), the contents search results display control portion 31 senses whether or not the return key (soft key 24) is pushed (step S602). If such display control portion senses that the return key is pushed, the display portion returns to the image 403 of the information tab shown in FIG. 14(a) (i.e., the process goes to step S510 in a flowchart in FIG. 7). Therefore, the display portion is brought into such a state that the operator can select the “that day image check” or the “that day mail check” once again.

In contrast, if the contents search results display control portion 31 does not sense that the return key is pushed, such display control portion senses whether or not the up/down key of the navigation key 21 is pushed (step S603). As shown in FIG. 14(b), first the cursor is displayed (highlighted display) at the top of the mail list. Thus, the operator can move the cursor to a desired position by pushing the up/down key (step S604). Then, the contents search results display control portion 31 senses whether or not the select key (soft key 22) is pushed (step S605). If such display control portion senses that the select key is pushed, it displays a full text of the electronic mail (not shown) (step S606). In the state that the full text is being displayed, the contents search results display control portion 31 senses whether or not the return key (soft key 24) is pushed (step S607). If such display control portion senses that the return key is pushed, the display portion returns to the image 503 of the that day mail list shown in FIG. 14(b) (i.e., process goes to step S605). Therefore, the display portion is brought into such a state that the operator can select the electronic mail, the detailed display of which he or she needs, once again. With the above, the displaying process of the that day mail is ended.

Next, FIG. 10 is a flowchart showing procedures of a displaying process of the image file acquired or generated on that day. If the “that day image check” is selected in the display state of the image 403 of the information tab shown in FIG. 14(a), the contents search results display control portion 31 generates and displays the image 502 of the that day mail list shown in FIG. 14(c), based on the list information of the image file acquired in step S104 in FIG. 3 (step S801).

In the display state shown in FIG. 14(c), the contents search results display control portion 31 senses whether or not the “return key” (soft key 24) is pushed (step S802). If such display control portion senses that the return key is pushed, the display portion returns to the image 403 of the information tab shown in FIG. 14(a) (i.e., the process goes to step S510 in a flowchart in FIG. 7). Therefore, the display portion is brought into such a state that the operator can select the “that day image check” or the “that day mail check” once again.

In contrast, if the contents search results display control portion 31 does not sense that the return key is pushed, such display control portion senses whether or not the up/down key of the navigation key 21 is pushed (step S803). As shown in FIG. 14(c), first the cursor is displayed (highlighted display) at the top of the image file list. Thus, the operator can move the cursor to a desired position by pushing the up/down key (step S804). Then, the contents search results display control portion 31 senses whether or not the “mail key” (soft key 25) is pushed (step S805). If such display control portion senses that the mail key is pushed, the list of the text shown in FIG. 14(c) is changed into the image 503 of the that day image thumbnail list on a thumbnail display basis shown in FIG. 14(d) (step S806).

Then, the contents search results display control portion 31 senses whether or not the “select key” (soft key 22) is pushed (step S807). If such display control portion senses that the select key is pushed, it displays an enlarged image of that image file (not shown) (step SS808). In the enlarged display state, the contents search results display control portion 31 senses whether or not the return key (soft key 24) is pushed (step S809). If such display control portion senses that the return key is pushed, the display portion returns to the image 502 of the that day image list shown in FIG. 14(c) (or the image 503 of the that day image thumbnail list shown in FIG. 14(d)) (i.e., process goes to step S807). Therefore, the display portion is brought into such a state that the operator can select the image, the enlarged display of which he or she needs, once again. With the above, the displaying process of the that day image is ended.

With the above, the procedures of the displaying process of the information files are ended. As explained in the examples of the screen display from FIG. 12 to FIG. 14, the tab can be switched by the left/right key of the navigation key 21 and also the data item in each tab can be moved (scrolled) by the up/down key of the navigation key 21. In other words, all the searched results of a plurality of contents, the files containing the searched results of which are arranged in a predetermined layout every application, can be displayed by the same key operations. As a result, the present embodiment is very available for the display of the cellular phone terminal whose operation is simple and whose size is small.

### Embodiment 2

Next, another example in which the searched results of a plurality of applications are displayed in the same cellular phone terminal as that explained in the embodiment 1 by using the date as the search condition key similarly will be explained hereunder. Here, a configuration of the cellular phone terminal in an embodiment 2 is similar to that of the cellular phone terminal in the embodiment 1.

FIG. 15 is a view showing an example of the screen display of the cellular phone terminal in the embodiment 2 of the present invention when searched results in a plurality of applications are displayed by using the date as the search condition. In the present embodiment, the applications as the searched object (i.e., the linked applications) are set in such a way that these applications can be changed according to that the selected date is the past or the future. Therefore, a layout of the screen that displays the searched result is also changed according to the date. In an example shown in FIG. 15, when the past date is selected, that day schedule, weather information, image list, dairy, memo of text, and the like are searched. Also, when the future date is selected, that day schedule, weather information, fortune information, memo of text, and the like are searched and then the items of all searched results are displayed in a predetermined layout in one format every application. All items can be displayed only by longitudinal scroll (e.g., the up/down key of the navigation key 21) without the classification of contents by the tab like the embodiment 1. In this case, when the operator wishes to display the detailed information about respective contents, he or she selects such information by another key operation (e.g., by pushing the soft key 22). By the way, the information about the weather information, the fortune information, etc. on that date is acquired by starting the Web browser to access the particular Web site. Now, since the procedures of the contents searching and results displaying operations of the cellular phone terminal in the embodiment 2 correspond to those in the embodiment 1, their explanation will be omitted herein.

### Embodiment 3

Next, still another example in which the searched results of a plurality of applications are displayed in the same cellular phone terminal as that explained in the embodiments 1 and 2 by using the name as the search condition key will be explained hereunder. Here, a configuration of the cellular phone terminal in an embodiment 3 is similar to that of the cellular phone terminal in the embodiment 1.

FIG. 16 is a view showing an example of the screen display of the cellular phone terminal in the embodiment 3 of the present invention when searched results in a plurality of applications are displayed by using the name as the key. The searches results in a plurality of applications searched with respect to the name are displayed collectively by causing the contents search results display control portion 31 to execute a “name-associated contents search results display program”. In the example shown in FIG. 16, data such as the newest date at which the electronic mail was sent to the destination of the name, the newest date at which the electronic mail was received from the destination of the name, the phone number and the address, the phone melody title, the birthday, etc. are searched while linking to a mailer, a scheduler, an address note tool, a data management tool, etc., and all items of the searched results are arranged in a predetermined layout in one format and displayed.

Although not shown in the example of the screen display in FIG. 16, a history of the electronic mails exchanged with the destination of the name can be displayed as a list in association with the designated name. At that time, if an icon is displayed based on the similar procedures to the embodiment 1, it can be easily discriminated whether the electronic mail should be the incoming mail from the destination or the outgoing mail to the destination. Also, since the function of the mailer can be utilized based on the attribute information by arranging the electronic mail files together with the attribute information, one electronic mail file can be selected from the history of the electronic mails and then the operator can reply to the electronic mail or forward the electronic mail. Here, since the procedures of the contents searching and results displaying operations of the cellular phone terminal in the embodiment 3 also correspond to those in the embodiment 1, their explanation will be omitted herein.

In the above “date-associated contents search results display program” and the above “name-associated contents search results display program”, any application may be selected as the searched object if such application can be searched by using the “date” or the “name” as the key. Also, a sequence of searches is not restricted to the embodiment, and such sequence may be set appropriately.

Also, in all above embodiments, the display layouts of the searched results are given only as one example, and the layout is not limited to them. In addition, the search transition is not limited to the “date” and the “name”. But it is needless to say that the search can be conducted by using any condition as the key and then the files, which contain the contents that meet the search condition, out of a plurality of files that correspond to a plurality of applications respectively can be displayed.

As described above, according to the present invention, since an arranging unit for arranging the acquired filed in a predetermined layout every application is provided, the results searched from a plurality of applications can be displayed intensively. Therefore, while solving the problem peculiar to the mobile information terminal, i.e., a size of the housing is small and a display area is restricted, the searched results of a plurality of applications can be arranged/displayed intensively on the same screen such that the file including the contents that meet the search condition can be grasped comprehensively and also the convenience can be improved.

The present invention is explained in detail with reference to the particular embodiments. But it is apparent for those skilled in the art that various variations and modifications can be applied without departing a spirit and a scope of the present invention

This application is based upon Japanese Patent Application (Patent Application No. 2004-292648) filed on Oct. 5, 2004, and the contents thereof are incorporated herein by reference.

### INDUSTRIAL APPLICABILITY

Since an arranging unit for arranging the acquired files in a predetermined layout every application is provided, the present invention can display the results searched from a plurality of applications. Therefore, the present invention is able to posses such advantages that the files including the contents that meet the search condition can be grasped comprehensively and also the convenience can be improved, and is useful for the mobile information terminal, the display control program for the same, and the like.

1: A mobile information terminal including a display portion for displaying contents of a plurality of files corresponding to respective applications, comprising:
an acquiring unit that acquires files containing the contents which meet a search condition;
an arranging unit that arranges the acquired files in a predetermined layout every application; and
a display controlling unit that causes the display portion to display the arranged files.

2: The mobile information terminal according to claim 1, wherein the arranging unit arranges the files containing the contents which meet the search condition, together with attribute information of the files.

3: The mobile information terminal according to claim 1, wherein the arranging unit arranges the files containing the contents, which meet the search condition, in a display area displayed by scrolling the files.

4: The mobile information terminal according to claim 1, wherein the arranging unit classifies the files containing the contents, which meet the search condition, on a tab basis every application and arranges the files.

5: The mobile information terminal according to claim 1, wherein the display controlling unit causes the display portion to display an outgoing electronic mail and an incoming electronic mail distinguishably.

6: The mobile information terminal according to claim 1, wherein the arranging unit arranges the acquired image files as thumbnails.

7. (canceled)

8: A method of displaying contents of a plurality of files corresponding to respective applications on a display portion, comprising:
acquiring files containing the contents which meet a search condition;
arranging the acquired files in a predetermined layout every application; and
displaying the arranged files on the display portion.

9: The method according to claim 8, wherein the files containing the contents which meet the search condition are arranged together with attribute information of the files.

10: The method according to claim 8, wherein the files containing the contents, which meet the search condition, are arranged in a display area displayed by scrolling the files.

11: The method according to claim 8, wherein the files containing the contents, which meet the search condition, are classified on a tab basis every application; and
wherein the classified files are arranged.

12: The method according to claim 8, wherein an outgoing electronic mail and an incoming electronic mail are displayed distinguishably.

13: The method according to claim 8, wherein the acquired image files are arranged as thumbnails.
